(19) United States
(12) Patent Application Publication
(10) Pub. No.: US 2012/0207417 A1
(43) Pub. Date: Aug. 16, 2012

(54) NON-CONTACT SEALING RING AND SEALING ARRANGEMENT

(75) Inventors: Wilhelm Walter, Poppenhausen (DE); Erwin Hartmann, Bergrheinfeld (DE)

(73) Assignee: SCHAEFFLER TECHNOLOGIES AG & CO. KG, Herzogenaurach (DE)

(21) Appl. No.: 13/503,230

(22) PCT Filed: Sep. 23, 2010
(86) PCT No.: PCT/EP10/64008

§ 371 Date: Apr. 20, 2012

(30) Foreign Application Priority Data
Oct. 22, 2009 (DE) 10 2009 050 215.7

(51) Int. Cl. F16C 33/76; F01D 11/02

(52) U.S. Cl. 384/477; 277/411

(57) ABSTRACT

A sealing ring for sealing a rolling chamber of a rolling bearing, which has a supporting part that is fixed to a first bearing part and retains an elastic part. The sealing ring seals the roiling chamber by a radial or axial sealing lip on the elastic part. The sealing ring lies between the first bearing part and a second bearing part that is rotatable relative to the first bearing part or lies between the first bearing part and another component fixed to the second bearing part and moveable relative to the first bearing part. A ring of lubricant is applied, formed and retained by an annular groove in a sealing lip and by the second bearing part or by the component. The ring of lubricant can also be shaped so that the ring of lubricant closes a gap between the sealing lip and the second bearing part or the components.

### FIELD OF THE INVENTION

The invention relates to a sealing ring for sealing a rolling space of an antifriction bearing, the sealing ring having a carrier part, which is provided for fastening purposes on a first bearing part and holds an elastic part, and the sealing ring being provided by means of a radial or axial sealing lip on the elastic part for sealing the rolling space between the first bearing part and a second bearing part, which can be rotated relative to the first bearing part, or between the first bearing part and another component which is fastened to the second bearing part and can be moved relative to the first bearing part. Furthermore, the invention relates to a sealing arrangement having a sealing ring of this type.

A sealing ring of this type or a sealing arrangement of this type is used in antifriction bearings, the rolling space of which has to be shielded or sealed from the external surroundings. This results in the problem that a first bearing part has to move relative to a second bearing part, rolling bodies which transmit a load from the first bearing part to the second bearing part or vice versa being installed between the bearing parts. Here, the rolling bodies are situated in the rolling space, that is to say in a space which has to be sealed from the surroundings and as a rule is delimited by the two bearing parts and also possibly by further bearing parts or components.

The rolling space is to be kept free, in particular, of contaminants which can lead to a pitting effect, that is to say cause damage to the running faces of the bearing parts, such as inner rings or outer rings, and therefore reduce the service life of the antifriction bearing. The penetration of moisture is likewise disadvantageous, since pitting which occurs can likewise lead to damage to the running face in or of the running bodies. Antifriction bearings are therefore provided with what are known as rubbing sealing arrangements which have at least one axial or radial sealing lip which bears rubbingly against the bearing part which can be moved relative to the sealing lip. In order to reduce friction, this bearing face or else sealing face is provided with a lubricant, with the result that the coefficient of friction of the antifriction bearing remains low despite rubbing seals. However, the friction still causes a disadvantageous energy consumption.

In the field of wheel bearings for passenger cars or trucks, for example, wheel bearings which seal rubbingly in this way are used. Unfortunately, on account of their coefficient of friction, they cause high fuel consumption; attempts have already been made in the past to reduce this using various approaches. Here, however, a high coefficient of friction would always be accepted if the wheel bearing had to be used under demanding operating conditions, for example in the case of a high degree of contamination or great humidity.

WO 2008/102505 A1 has disclosed cassette seals which use both radially rubbingly bearing sealing lips and axially rubbingly bearing sealing lips which are held by a carrier part and bear against a thrower ring. The number of rubbing sealing lips and their prestress with respect to the run-on face are varied as a function of the sealing requirements.

### SUMMARY OF THE INVENTION

The invention is based on the object of specifying a cost-effective, low-friction sealing arrangement which is simple to install, and is suitable for sealing rolling spaces of anifriction bearings, in particular wheel bearings, from the surroundings.

In a sealing ring or a sealing arrangement of the type mentioned in the introduction, this object is achieved by the fact that the sealing lip is provided for forming a gap with the second bearing part or with the component, and the sealing lip has an annular groove for forming a lubricant ring which closes the gap.

The invention is based on the finding that an alternative to the rubbing sealing lip of the sealing arrangement does not necessarily have to be a gap seal, in order to protect the rolling space against the penetration of dirt particles and moisture from the surroundings of the antifriction bearing.

The sealing ring according to the invention for sealing a rolling space of an antifriction bearing is provided for fastening on a first bearing part. This can take place, for example, by way of a press fit with a suitable radius selection or by way of a rubber snap-action device on the sealing ring in combination with a groove on the first bearing part. The sealing ring has a carrier part which is provided for holding an elastic part, on which a radial and/or axial sealing lip is shaped. In this context, a radial sealing lip means that a lip is intended to seal in the radial direction with respect to the rotational axis of the antifriction bearing, in a rubbing manner or without contact, relative to a bearing part or component. This applies correspondingly to axial sealing lips which act parallel to the rotational axis. Combinations are also conceivable, that is to say a sealing lip which has both an axial component and a radial component.

The sealing ring is provided for sealing between the first bearing part and the second bearing part which can rotate relative to the first bearing part. This takes place firstly by the carrier part which holds the elastic part, in combination with the sealing lip of the elastic part. If the sealing ring is therefore inserted, for example, between the first and the second bearing part, this already represents a complete sealing arrangement which possibly does not require any further sealing components, such as a thrower ring.

For example, the first bearing part is a stationary outer ring of a wheel bearing and the second bearing part is the wheel hub or a rotatable inner ring, as is known from passenger cars. In trucks on the other hand, the second bearing part is arranged in a stationary manner and the first bearing part is arranged in a rotatable manner. In every case, the two bearing parts are arranged such that they can be rotated relative to one another.

It is provided according to the invention that the sealing lip forms a gap with the second bearing part or with the component. This corresponds first of all to all properties of a gap seal. However, the sealing lip has, furthermore, an annular groove for forming a lubricant ring which closes the gap. Said lubricant ring consists of lubricant and has its shape defined by the sealing lip and/or by its annular groove. In the operating state, the lubricant ring is to be shaped not only by the annular groove, but also by the second bearing part or the component which can be, for example, an element of the sealing arrangement, in particular a thrower ring. The lubricant ring can therefore be formed at least on one side, but also on two sides, by concave shapes which are preferably directed in the axial direction and belong in each case to bearing parts of the first bearing part and of the component, which bearing parts can be moved relative to one another. The consistency of the lubricant, in particular its viscosity, ensures that it is ruled out that the lubricant runs out through the gap in the direction of the rolling space or in the opposite direction. During operation, the lubricant ring will no longer consist of pure lubricant, but rather can be augmented over time by foreign particles, with the result that the viscosity changes. These viscosity fluctuations would have to be taken into consideration during the fixing of the gap width, with the result that an outflow can be largely prevented.

Secondly, it is conceivable that a continuous outflow is permitted into the operating surroundings of the antifriction bearing or into intermediate spaces of the sealing arrangement which are arranged upstream (optionally with collection channel), in order to bring about continuous flushing of foreign particles out of the lubricant ring, and the sealing action of the lubricant ring can be kept constant in the relatively long term, or can advantageously be checked. A collection channel which is mounted upstream of the gap is appropriate, since it facilitates circumferential discharge of the flushed dirt particles and conveys them by gravity downward out of the sealing arrangement.

In one advantageous embodiment, the annular groove is formed by a first projection in a second projection of the sealing lip. Both projections, or else only one of the two projections, are/is suitable for realizing the desired gap width, by the projection being guided correspondingly closely to the second bearing part or the component. In this context, it is possibly appropriate to vary the width of the gap over the annular groove of the sealing lip, with the result that the outflow can be guided in an advantageous direction. It is thus conceivable, for example, that the first projection forms a wider gap than the second projection, in order that, for example in the case of a temperature increase or another loading, the lubricant which contains dirt particles is guided past the first projection into an intermediate space of the sealing arrangement or into a collection channel. If the antifriction bearing has few lubricant reserves internally, it is possible to effect the width variation of the gap inversely, with the result that the lubricant is held in the roiling space.

The first projection advantageously has a first face for forming the gap with a first corresponding face of the component or of the second bearing part. Furthermore, concrete properties of the first face and of the first corresponding face can be used to control the outflow of lubricants. For example, blade-like ribs or grooves or another structure which can be used to convey the lubricant in one direction or the other would be conceivable at this point. The second projection advantageously has a second face for forming the gap with a second corresponding face of the component or of the second bearing part. Here, similar advantages are produced as in the case of the corresponding measures with the first face and the first corresponding face.

In one advantageous embodiment, the lubricant ring which is fit in the annular groove consists of grease or a sufficiently viscous oil. An optimum sealing action can be ensured by a preselection of the viscosity.

In one advantageous embodiment, the second bearing part is a hub, wheel hub or an inner ring.

In one advantageous embodiment, the component is a second sealing ring or thrower ring. The component can belong to the sealing arrangement, or else can be a component which has another function. In combination with the sealing ring according to the invention, the second sealing ring advantageously leads to an increased sealing action. Firstly, the component has, for example, one or both of the abovementioned corresponding faces or assists the shaping of the lubricant ring by virtue of the fact that a concave shaped-out molding is formed on the component. A concave shaped-out molding of this type can be formed by a channel, as can be produced by an elbow of a sealing or thrower ring consisting of metal. Since elbows or bends (multiple elbows) of this kind frequently occur in sealing arrangements of this type, a synergy effect can be achieved here by said channel being used to form the lubricant ring.

In one advantageous embodiment, the first bearing part is an outer ring or a wheel hub.

In one advantageous embodiment, a further axial and/or radial sealing lip are/is shaped on the elastic part. The sealing lip according to the invention with its lubricant ring can advantageously be used readily in combination with other sealing lips, such as form a preseal, for example. Secondly, the sealing lip according to the invention can be used to collect foreign particles and to protect a sealing lip connected downstream against said foreign particles.

A sealing arrangement which can be configured, for example, as a cassette seal advantageously has one or more first sealing rings according to the invention which are in each case assigned to a second sealing ring, it being possible for the second sealing ring or rings to be fastened to the second bearing part.

In one advantageous embodiment, the second sealing ring or one of its constituent parts is provided for making contact with the lubricant ring in the annular groove of the first sealing lip and has the first and/or second corresponding face. The second sealing ring which can be, for example, a thrower ring therefore interacts in an optimum manner with the first sealing ring, it being possible for the outflow from the lubricant ring to be controlled by a corresponding design of said faces and for the cross-sectional shape of the lubricant ring to be controlled by the design of the component between or on said faces, The volume of the lubricant ring can therefore be designed in such a way that the required quantity of lubricant is present to close the lubricant in a watertight manner.

The cross-section of the lubricant ring can assume a very wide variety of shapes here; circular or ellipsoidal cross-sections are the simplest to achieve.

The constituent part of the second sealing ring is advantageously an at least partially annular and/or a partially hollow-cylindrical constituent part. This ensures that the constituent part assists the dimensional stability of the lubricant ring circumferentially. However, it is also conceivable that another constituent part or component is inserted in sections in the circumferential direction for the dimensional stability of the lubricant ring. It is possible here to vary the cross-sectional area of the lubricant ring in the circumferential direction, in order to control the lubricant flow in the circumferential direction or to accelerate it in places, in order to produce an increased lubricant flow, for example, at highly contaminated places.

The constituent part of the second sealing ring is advantageously formed by an elbow or a bend of the second sealing ring. Elbows or bends of this type are used, for example, to attach a magnetizable or magnetic material, in particular a transducer ring, such as a multipole encoder, to the second sealing ring in the coupling region. A particularly space-saving arrangement is therefore possible, in which the multipole encoder is firstly arranged so as to lie on the outside axially and radially, and the lubricant ring according to the invention is arranged so as to lie on the inside radially and axially. It is possible as a result to provide a sealing arrangement with a low axial width which in turn has a positive effect on the axial width of the antifriction bearing.

Further advantageous embodiments and preferred developments of the invention can be gathered from the description of the figures and/or the subclaims.

In the following text, the invention will be described and explained in greater detail using the exemplary embodiments which are shown in the figures.

### BRIEF DESCRIPTION OF THE FIGURES

In the drawing:

FIG. 1 shows a first sealing arrangement for a wheel bearing, which sealing arrangement is configured as a cassette seal,

FIG. 2 shows a second sealing arrangement for a wheel bearing, which sealing arrangement is configured as a cassette seal,

FIG. 3 shows a third sealing arrangement for a wheel bearing, which sealing arrangement is configured as a cassette seal, and

FIG. 4 shows a fourth sealing arrangement for a wheel bearing, which sealing arrangement is configured as a cassette seal.

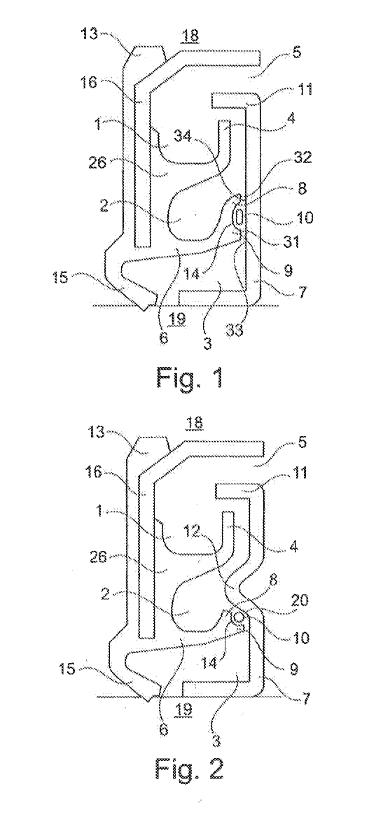

FIG. 1 shows a first sealing arrangement for a wheel bearing, which sealing arrangement is configured as a cassette seal. The sealing arrangement consists of a component 7, which is configured as a thrower ring 7, and a sealing ring, which consists of a carrier part 16 and an elastic part 26 made from an elastomer, for example.

The carrier part 16 is fastened by means of a press fit to the outer ring 18, which is fastened to a wheel carrier (not depicted), that is to say represents a stationary outer ring 18. The elastic part 26 contains a statically sealing projection 13 which does not allow the penetration of moisture which has passed between the outer ring 18 and the carrier part 16 to penetrate further into the rolling space.

Furthermore, the elastic part 26 has a radial sealing lip 15 which bears rubbingly against the inner ring 19 and is prestressed by its inherent elasticity against the latter. Furthermore, the elastic part 26 has an axial sealing lip 4 which first of all extends in an axial direction, but moves into a radial direction, extends in the radial direction parallel to the thrower ring 7 and, with the latter, forms a sealing gap which is covered radially by means of an end piece 11 of the thrower ring 7, with the result that the gap opening is directed axially toward the rolling space of the radial bearing.

The kinked shape of the axial sealing lip 4 forms a collection channel 1 which is arranged radially within the gap opening between the axial sealing lip 4 and the end piece 11. Although it is therefore possible in principle that foreign particles and moisture enter through the gap opening 5 which lies radially further to the outside, said foreign particles and moisture are discharged via the collection channel 1 without passing into the intermediate space of the collection channel 2.

The thrower ring 7 is fastened by means of a press fit on the inner ring 19 and has an axially and a radially oriented constituent part. The end piece 11 is oriented axially, just like the part of the thrower ring 7 in the region of the inner ring 19. Said parts of the inner ring 7 have a hollow-cylindrical shape. The corresponding faces 33 and 34 which, together with faces 32 and 31 of the axial sealing lip 6, form a gap in the radial direction are situated on the annular part of the thrower ring 7.

A lubricant ring 10 which assumes a substantially elliptical shape in longitudinal section (as shown in FIG. 1) is situated between the face pairs 32, 34 and 31, 33. However, on account of its shape, the annular groove leads to the lubricant ring assuming a substantially convex shape in the sectional plane shown in the figure and, directed in an axially opposed manner, assuming a substantially flat shape on account of the flat inner side of the thrower ring 7. To this extent, the axial sealing lip 6 and the thrower ring 7 shape the lubricant ring 10. The face pairs can advantageously be separated further radially from one another, whereby the lubricant ring 10 becomes more elliptical in section and therefore its volume increases. A large lubricant reservoir is therefore produced which can also afford to receive foreign particles, without it being necessary to accept damage to the sealing action.

The spacing of the faces 32 and 34 is advantageously smaller than the spacing of the faces 31 and 33. This prevents an outflow of the lubricant, which is disadvantageously assisted by the centrifugal forces of a rotational movement of the thrower ring 7. In every case, the gap opening is to be coordinated with the viscidity or viscosity of the lubricant which is used.

The axial sealing lip 6 is advantageously shaped in such a way that it forms a collection channel 2 which collects dirt particles and water which enter and prevents contact with the lubricant ring during the outflow along the axial sealing lip 4.

The intermediate space 3 or the radial sealing lip 15 is advantageously connected downstream of the axial sealing lip 6, whereby a sealing action can still be maintained after the lubricant in the lubricant ring 10 is used up. Here, the axial sealing lip 6 forms merely a further gap seal together with the thrower ring 7.

FIG. 2 shows a further sealing arrangement for a wheel bearing, which sealing arrangement is configured as a cassette seal. The second cassette seal differs from the first cassette seal of FIG. 1 as a result of another configuration of the sealing lip 6 and of the thrower ring 7. The comments with respect to FIG. 1 apply to constituent parts which are unchanged in comparison with the first cassette seal.

The fact is advantageous that the thrower ring 7 then has a bend 12 which forms, in particular, a channel 20 which is arranged between the face pairs and therefore contributes to the shaping of the lubricant ring 10. The channel 20 and the annular groove 14 form a substantially circular delimitation in the sectional plane. A disadvantageous distribution of foreign particles which is possibly caused by centrifugal forces or other forces which occur is suppressed by the fact that the radial and axial path which a foreign particle can cover within the lubricant ring 20 is substantially identical.

Furthermore, the bend 12 leads to the part gap which is formed on the projection 8 of the axial sealing lip 6 being oriented substantially in the axial direction, whereby the effect of the lubricant outflow as a result of a centrifugal force can be largely suppressed. A part gap which extends completely in the axial direction at this point would completely suppress this effect. However, an axial sealing lip 6 with its projection 8, as shown in FIG. 2, also leads, in the case of a centrifugal force, to the axial sealing lip in the region of the projection 8 migrating in the radial direction to the bend of the thrower ring 7 and reducing the width of the part gap and therefore preventing the outflow.

The advantage of a part gap on the projection 8, which part gap does not extend completely in the axial direction, additionally comprises the fact that, even when water is running out of the collection channel 2, it does not come into contact with the lubricant ring 10, since said water can flow from the axial sealing lip 6 directly onto the bend 12 and is discharged further to the outside through the gap between its axial sealing lip 4 and the end piece 11.

The intermediate space 3 can advantageously serve as a lubricant reservoir which supplies the lubricant ring 10 continuously with lubricant via the part gap between the projection 9 of the axial sealing lip 6 and the thrower ring 7.

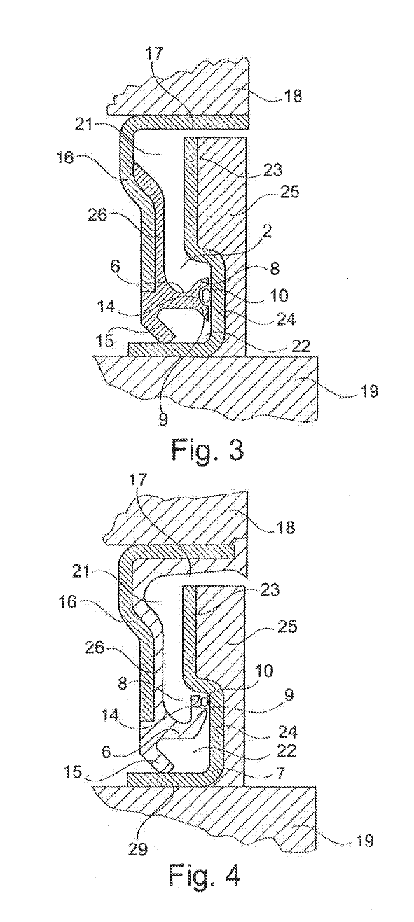

FIG. 3 shows a third sealing arrangement for a wheel bearing, which sealing arrangement is configured as a cassette seal. Reference can be made to the comments made with respect to FIG. 1, the first sealing arrangement which is shown there having a preseal with a collection channel which is replaced in the third sealing arrangement of FIG. 3 substantially by an arrangement of a transducer ring.

Together with the outer ring part 23 and the carrier part 16, the transducer ring 25 advantageously forms an inlet gap 26 which seals the intermediate space 21 toward the surroundings of the antifriction bearing.

In addition to the advantageous spatial arrangement of the transducer ring 25, a special protective mechanism for the axial sealing lip 6 or the lubricant ring 10 is additionally produced by the fact that dirt particles which penetrate through the inlet gap 17 are conducted by the water in the radial direction along the outer ring part 23 toward the inner ring 19 and are then collected in the collection channel 2. It is therefore more difficult for the foreign particles to reach the lubricant ring 10, whereby the service life is increased overall.

This increase in the service life is therefore achieved by two elbows of the thrower ring 7 which lead to the two ring parts 23 and 24 which extend in the radial direction and are offset in the axial direction with respect to one another, the outer ring part 23 being displaced axially in the direction of the rolling space and the inner ring part 24 being displaced axially in the opposite direction. Both are integral constituent parts of the thrower ring 7.

FIG. 4 shows a fourth sealing arrangement for a wheel bearing, which sealing arrangement is configured as a cassette seal. In comparison with the second sealing arrangement of FIG. 2, the fourth sealing arrangement which is shown in FIG. 4 does not have an axial sealing lip 4, but rather has a smaller inlet gap which is formed by the elastic part 26, the outer ring part 23 of the thrower ring 7 and the transducer ring 25.

Furthermore, it is possible to arrange a substantial portion of the transducer ring 25 axially next to the outer ring part 23. Firstly, the protruding protection of the axial sealing lip and of the lubricant ring 10 can therefore be brought about in a similar way as in the second sealing arrangement of FIG. 2, but the main portion of the transducer ring 25 can be arranged so as to lie radially on the outside with respect thereto. This special arrangement of the transducer ring 25 therefore leads to a position of the lubricant ring 10, which position is advantageous for the service life of the sealing arrangement.

As an alternative or in addition, insofar as it is possible, part of the transducer ring 25 can also extend next to an inner ring part 24 of the thrower ring 17. It is important, however, that the volume which is available for the transducer ring 25 can be kept very large, without it being necessary for additional width axially. As a consequence, antifriction bearings, in particular wheel bearings, can also be produced with an advantageously small axial width.

### DETAILED DESCRIPTION OF THE FIGURES

In summary, the invention relates to a sealing ring for sealing a rolling space of an antifriction bearing, the sealing ring having a carrier part, which is provided for fastening purposes on a first bearing part and holds an elastic part, and the sealing ring being provided by means of a radial or axial sealing lip on the elastic part for sealing the rolling space between the first bearing part and a second bearing part which can be rotated relative to the first bearing part, or between the first bearing part and another component which is fastened to the second bearing part and can be moved relative to the first bearing part. The aim is to specify a sealing ring or sealing arrangement which is cost-effective, easy to install and exhibits low friction. To this end, a lubricant ring is used which is formed and held by an annular groove in a sealing lip and secondly is at least held, or else can also be shaped, by the second bearing part or the component, with the result that the lubricant ring closes a gap between the sealing lip and the second bearing part or the components.

### LIST OF DESIGNATIONS

1 First Collection Channel
2 Second Collection Channel
3 Intermediate Space
4 Sealing Lip
5 Gap Seal
6 Axial Sealing Lip
7 Component
8 First Projection
9 Second Projection
10 Lubricant Ring
11 End Piece
13 Sealing Piece
14 Annular Groove
15 Radial Sealing Lip
16 Carrier Part
18 Outer Ring
19 Inner Ring
20 Channel
21 Intermediate Space
22 Intermediate Space
23 Outer Ring Part
24 Inner Ring Part
25 Transducer Ring
26 Elastic Part
31 Second Face
32 First Face
33 Second Corresponding Face
34 First Corresponding Face

1-15. (canceled)

16. A sealing ring for sealing a rolling space between a first bearing part and a second bearing part of an antifriction bearing, the sealing ring, comprising:
a carrier part fastenable on the first bearing part;
a component fastenable to the second bearing part and moveable relative to the first bearing part; and
an elastic part secured to the carrier part and having a radial or an axial sealing lip for sealing a rolling space between the first bearing part and the second bearing part, which can be rotated relative to the first bearing part or between the first bearing part and the component,
wherein the sealing lip forms a gap with the second bearing part or with the component, and the sealing lip has an annular groove for forming a lubricant ring, that closes the gap.

17. The sealing ring as claimed in claim 16, wherein the sealing lip has a first projection that forms the annular groove.

18. The sealing ring as claimed in claim 16, wherein the sealing lip has the first projection and a second projection that form the annular groove.

19. The sealing ring as claimed in claim 17, wherein at least the first projection has a first face for forming the gap with a first corresponding face of the component or the second bearing part.

20. The sealing ring as claimed in claim 18, wherein the second projection has a second face for forming the gap with a second corresponding face of the component or the second baring part.

21. The sealing ring as claimed in claim 16, wherein the lubricant ring consists of grease fit in the annular groove.

22. The sealing ring as claimed in claim 16, wherein the second bearing part is a wheel hub or an inner ring.

23. The sealing ring as claimed in claim 16, wherein the component is a second sealing ring.

24. The sealing ring as claimed in claim 16, wherein the first bearing part is an outer ring or a wheel hub.

25. The sealing ring as claimed in claim 16, wherein the elastic part has a further axial and/or radial sealing lip.

26. A sealing arrangement for sealing a rolling space between a first bearing part and a second bearing part of an antifriction bearing, the sealing arrangement, comprising:
a first sealing ring having a carrier part fastenable on the first bearing part, a component fastenable to the second bearing part and moveable relative to the first bearing part, and an elastic part secured to the carrier part and having a radial or an axial sealing lip for sealing a rolling space between the first bearing part and the second bearing part, which can be rotated relative to the first bearing part or between the first bearing part and the component, wherein the sealing lip forms a gap with the second bearing part or with the component, and the sealing lip has an annular groove for forming a lubricant ring, that closes the gap; and
a second sealing ring, which is fastenable to the second bearing part.

27. The sealing arrangement as claimed in claim 26, wherein the second sealing ring or a constituent part of the second sealing ring is arranged to make contact with the lubricant ring in the annular groove of the sealing lip and the second sealing ring has a first face and/or a second face that corresponds to a first face and a second face of the sealing lip.

28. The sealing arrangement as claimed in claim 27, wherein the constituent part of the second sealing ring is an at least partially annular and/or a partially hollow-cylindrical constituent part.

29. The sealing arrangement as claimed in claim 27, wherein the constituent part of the second sealing ring is formed by an elbow or a bend of the second sealing ring.

30. The sealing arrangement as claimed in claim 29, wherein the second sealing ring has a magnetizable or magnetic material in the bend region of the second sealing ring.

31. The sealing arrangement as claimed in claim 30, wherein the magnetic or magnetizable material is a transducer ring.

32. An antifriction bearing, comprising:
a first bearing part;
a second bearing part; and
a sealing ring for sealing a rolling space between the first bearing part and the second bearing part, the sealing ring having a carrier part fastenable on the first bearing part, a component fastenable to the second bearing part and moveable relative to the first bearing part, and an elastic part secured to the carrier part and having a radial or an axial sealing lip for sealing a rolling space between the first bearing part and the second bearing part, which can be rotated relative to the first bearing part or between the first bearing part and the component, wherein the sealing lip forms a gap with the second bearing part or with the component, and the sealing lip has an annular groove for forming a lubricant ring that closes the gap.

33. The antifriction bearing of claim 32, wherein the antifriction bearing is a wheel bearing.

34. An antifriction bearing, comprising:
a first bearing part;
a second bearing part; and
a sealing arrangement for sealing a rolling space between the first bearing part and the second bearing part, the sealing arrangement, comprising:
a first sealing ring having a carrier part fastenable on the first bearing part, a component fastenable to the second bearing part and moveable relative to the first bearing part, and an elastic part secured to the carrier part and having a radial or an axial sealing lip for sealing a rolling space between the first bearing part and the second bearing part, which can be rotated relative to the first bearing part or between the first bearing part and the component, wherein the sealing lip forms a gap with the second bearing part or with the component, and the sealing lip has an annular groove for forming a lubricant ring, that closes the gap; and
a second sealing ring, which is fastenable to the second bearing part.

35. The antifriction bearing of claim 34, wherein the antifriction bearing is a wheel bearing.
